(19) United States
(12) Patent Application Publication
(10) Pub. No.: US 2023/0278451 A1
(43) Pub. Date: Sep. 7, 2023

(54) POWER SUPPLY SYSTEM, SERVER, AND POWER BALANCING METHOD

(71) Applicant: TOYOTA JIDOSHA KABUSHIKI KAISHA, Toyota-shi, Aichi-ken (JP)

(72) Inventors: Masato EHARA, Gotemba-shi (JP); Daiki YOKOYAMA, Gotemba-shi (JP); Yuki TAKAHASHI, Susono-shi (JP); Tomoya TAKAHASHI, Ebina-shi (JP); Tomoyuki KUBOTA, Susono-shi (JP); Sachio TOYORA, Gotemba-shi (JP); Keisuke FUKUOKA, Fujieda-shi (JP); Zidan XU, Yokohama-shi (JP); Wenfeng LIANG, Yokohama-shi (JP); Hiroki MURATA, Gotemba-shi (JP)

(73) Assignee: TOYOTA JIDOSHA KABUSHIKI KAISHA, Toyota-shi, Aichi-ken (JP)

(21) Appl. No.: 18/054,031

(22) Filed: Nov. 9, 2022

(30) Foreign Application Priority Data
Jan. 11, 2022 (JP) 2022-002316

(51) Int. Cl. B60L 53/67; B60L 53/68; B60L 58/22; B60L 58/12; B60L 53/62

(52) U.S. Cl. CPC B60L 53/67; B60L 53/68; B60L 58/22; B60L 58/12; B60L 53/62

(57) ABSTRACT

A power supply system includes power supply equipment and a vehicle management device. The power supply equipment is configured to be supplied with electric power from an external power supply and supply the electric power to a vehicle traveling in a power supply lane. The vehicle management device is configured to manage a plurality of vehicles configured to transfer electric power to and from the power supply equipment. The vehicle management device is configured to select balancing vehicles to be controlled for power balancing of the external power supply. The vehicle management device is configured to, when the vehicle management device determines that the control of any of the balancing vehicles for power balancing of the external power supply has been stopped halfway through, select a substitute vehicle to be controlled for power balancing of the external power supply from the vehicles traveling in the power supply lane.

### CROSS-REFERENCE TO RELATED APPLICATION

This application claims priority to Japanese Patent Application No. 2022-002316 filed on Jan. 11, 2022, incorporated herein by reference in its entirety.

### BACKGROUND

1. Technical Field

The present disclosure relates to power supply systems, servers, and power balancing methods.

### 2. Description of Related Art

For example, Japanese Unexamined Patent Application Publication No. 2015-95983 (JP 2015-95983 A) discloses that energy management is performed through contactless charging (power receiving) or power supply by a vehicle parked on the premises of a house.

### SUMMARY

Electrified vehicles (xEVs) (e.g., battery electric vehicles) capable of storing electric power supplied from the outside of the vehicle can act as balancing power for an external power supply (e.g., balancing power for balancing supply and demand of electricity). In recent years, a technique for supplying electric power to moving xEVs has been attracting attention. It is possible to perform power balancing using this technique. Hereinafter, a lane equipped with power supply equipment will also be referred to as “power supply lane.” The power supply lane is also commonly referred to as “charging lane.”

By performing power balancing of the external power supply using vehicles traveling in the power supply lane, the power supply lane can provide balancing power to the external power supply. However, a selected balancing vehicle may not necessarily continue to perform power balancing of the external power supply to the end. The balancing vehicle may stop performing power balancing of the external power supply halfway through. For example, when the balancing vehicle leaves the power supply lane through its exit in the middle of power balancing of the external power supply, the balancing vehicle can no longer continue to perform power balancing via the power supply lane. Therefore, the balancing power provided from the power supply lane to the external power supply tends to be unstable.

The present disclosure was made to solve the above problem, and it is an object of the present disclosure to select vehicles for power balancing of an external power supply from vehicles traveling in a power supply lane so that the power supply lane is likely to provide stable balancing power to the external power supply.

A power supply system according to a first aspect of the present disclosure includes power supply equipment and a vehicle management device. The power supply equipment is configured to be supplied with electric power from an external power supply and supply the electric power to a vehicle traveling in a travel lane. The vehicle management device is configured to manage a plurality of vehicles configured to transfer electric power to and from the power supply equipment. The vehicle management device is configured to select balancing vehicles to be controlled for power balancing of the external power supply from the vehicles. The vehicle management device is configured to determine whether control of the balancing vehicles for power balancing of the external power supply has been stopped halfway through. The vehicle management device is configured to, when the vehicle management device determines that the control of any of the balancing vehicles for power balancing of the external power supply has been stopped halfway through, newly select a substitute vehicle to be controlled to perform power balancing of the external power supply from the vehicles traveling in the travel lane. Hereinafter, the travel lane (travel lane equipped with the power supply equipment as described above) will also be referred to as “power supply lane.”

According to such a configuration, even when the control of the balancing vehicle (vehicle selected for power balancing of the external power supply) for power balancing of the external power supply is stopped halfway through, the substitute vehicle is controlled to perform power balancing of the external power supply in place of that balancing vehicle. This reduces shortage of balancing power from the power supply lane. As a result, the power supply lane is likely to provide stable balancing power to the external power supply.

The balancing power means the capability in general to perform power balancing of the external power supply (frequency control, supply and demand balancing, etc.), and includes reserves. The external power supply may be a power grid (e.g., a microgrid or a large-scale power grid developed as an infrastructure). The external power supply may supply alternate current (AC) power or direct current (DC) power. The vehicle management device may be a stationary server or may be mounted on a mobile terminal. The vehicle management device may include one or more computers. The vehicle management device may be a cloud server.

in the power supply system according to the first aspect, when power balancing of the external power supply for a predetermined balancing duration is requested, the vehicle management device may monitor whether the balancing vehicles selected in response to this request are traveling in the power supply lane during the balancing duration. When any of the balancing vehicles has departed from the power supply lane during the balancing duration, the vehicle management device may determine that the control of that balancing vehicle for power balancing of the external power supply has been stopped halfway through.

According to such a configuration, it is possible to easily and accurately determine whether the control of the balancing vehicle for power balancing of the external power supply has been stopped halfway through.

In the power supply system according to the first aspect, the travel lane may be located on a same road as a no-power-supply lane. The vehicle management device may determine that the balancing vehicle has departed from the travel lane when the balancing vehicle has left the travel lane through an exit of the travel lane and when the balancing vehicle has changed from the travel lane to the no-power-supply lane.

According to such a configuration, it is possible to easily and accurately detect departure of the balancing vehicle from the power supply lane.

In the power supply system according to the first aspect, the vehicle management device may monitor a state of charge of an energy storage device of a selected balancing vehicle, and determine based on the state of charge whether the control of the balancing vehicle for power balancing of the external power supply has been stopped halfway through.

According to such a configuration, it is possible to easily and accurately determine whether the control of the balancing vehicle for power balancing of the external power supply has been stopped halfway through.

In the power supply system according to the first aspect, when the vehicle management device determines that the control of any of the selected balancing vehicles for power balancing of the external power supply has been stopped halfway through, the vehicle management device may preferentially select a vehicle located near the balancing vehicle the control of which has been stopped halfway through as the substitute vehicle from the vehicles traveling in the power supply lane.

The balancing power that acts on the external power supply when the balancing vehicle transfers electric power to and from the power supply equipment may vary depending on the position (location) of that balancing vehicle. In such a configuration, a vehicle located near the balancing vehicle the control of which for power balancing has been stopped halfway through is preferentially selected as the substitute vehicle. As a result, the power supply lane is likely to provide stable balancing power to the external power supply.

In the power supply system according to the first aspect, the vehicle management device may divide the power supply lane into a plurality of blocks and perform area management on a block-by-block basis. The vehicle management device may be configured to, when the vehicle management device determines that the control of any of the selected balancing vehicles for power balancing of the external power supply has been stopped halfway through, preferentially select a vehicle traveling in the same block of the power supply lane as the block in which the balancing vehicle the control of which has been stopped halfway through is traveling or a block associated with the block as the substitute vehicle.

The vehicle management device divides the power supply lane into a plurality of blocks, performs area management on a block-by-block basis, and associate areas (blocks) that are similar in the balancing power that acts on the external power supply when the balancing vehicle transfers electric power to and from the power supply equipment with each other. This makes it easier for the vehicle management device to select an appropriate substitute vehicle. In such a configuration, a vehicle traveling in the same block as the block in which the balancing vehicle the control of which for power balancing has been stopped halfway through is traveling or in a block associated with that block is preferentially selected as the substitute vehicle. Therefore, the power supply lane is likely to provide stable balancing power to the external power supply.

In the power supply system according to the first aspect, the vehicle management device may be configured to, when the vehicle management device determines that the control of any of the balancing vehicles for power balancing of the external power supply has been stopped halfway through, select the substitute vehicle from the vehicles traveling in the travel lane based on at least one of the following values of the energy storage device of each of the vehicles state of charge, full charge capacity, rated charge power, and rated discharge power.

According to such a configuration, it becomes easier for the vehicle management device to select an appropriate substitute vehicle according to the requested balancing power. The vehicle management device may be configured to preferentially select a vehicle equipped with an energy storage device with a large full charge capacity as the substitute vehicle from the vehicles traveling in the power supply lane. A vehicle equipped with an energy storage device with a larger full charge capacity tends to be more responsive to a power balancing request.

In the power supply system according to the first aspect, the vehicle management device may be configured to determine charge power for each balancing vehicle when charging of energy storage devices of the balancing vehicles is requested for power balancing of the external power supply, and send a first command to perform charging with the determined charge power to the balancing vehicles traveling in the travel lane.

In the above configuration, the vehicle management device can easily and accurately operate the energy storage device as balancing power by controlling each balancing vehicle (specifically, performing charge control of the energy storage device of each balancing vehicle) by, for example, remote control.

In the power supply system according to the first aspect, the vehicle management device may be configured to determine discharge power for each balancing vehicle when discharging of energy storage devices of the balancing vehicles is requested for power balancing of the external power supply, and send a second command to perform discharging of the determined discharge power or to stop charging to the balancing vehicles traveling in the travel lane.

In the above configuration, the vehicle management device can easily and accurately operate the energy storage device as balancing power by controlling each balancing vehicle (specifically, performing discharge control or charge stop control of the energy storage device of each balancing vehicle) by, for example, remote control.

In the power supply system according to the first aspect, the vehicle management device may be configured to predict the number of vehicles that are going to be traveling in the power supply lane during a predetermined period, and bid on balancing power for the predetermined period on an electricity market based on the predicted number of vehicles. According to this configuration, the vehicle management device is likely to win a bid on (contract) the available balancing power predicted from the number of vehicles (specifically, the number of vehicles traveling in the travel lane) for the day for which the power balancing is requested. The balancing power won by the vehicle management device is therefore likely to be provided from the travel lane to the external power supply as contracted.

A server according to a second aspect of the present disclosure is configured to manage a plurality of vehicles. Each of the vehicles managed by the server is configured to transfer electric power to and from power supply equipment. The power supply equipment is configured to be supplied with electric power from an external power supply and supplies the electric power to a vehicle traveling in a travel lane. The server is configured to select balancing vehicles to be controlled for power balancing of the external power supply from the vehicles. The server is configured to, when control of any of the selected balancing vehicles for power balancing of the external power supply has been stopped halfway through, newly select a substitute vehicle to be controlled to perform power balancing of the external power supply from the vehicles traveling in the travel lane.

According to such a configuration, like the power supply system described above, the vehicles to be controlled for power balancing of the external power supply (balancing vehicles or substitute vehicle) can be selected from the vehicles traveling in the power supply lane so that the power supply lane is likely to provide stable balancing power to the external power supply.

A power balancing method according to a third aspect of the present disclosure includes; selecting balancing vehicles to be controlled for power balancing of an external power supply from vehicles traveling in a travel lane equipped with power supply equipment configured to be supplied with electric power from the external power supply; controlling the balancing vehicles for power balancing of the external power supply; determining whether control of the balancing vehicles for power balancing of the external power supply has been stopped halfway through; when determination is made that the control of any of the balancing vehicles for power balancing of the external power supply has been stopped halfway through, newly selecting a substitute vehicle to be controlled to perform power balancing of the external power supply from the vehicles traveling in the travel lane; and controlling the substitute vehicle for power balancing of the external power supply.

According to such a configuration, like the power supply system described above, the vehicles to be controlled for power balancing of the external power supply can be selected from the vehicles traveling in the power supply lane so that the power supply lane is likely to provide stable balancing power to the external power supply. Power balancing of the external power supply can thus be performed by the selected vehicles.

According to the present disclosure, it is possible to select a balancing vehicle from a vehicle group traveling in a power supply lane so that the power supply lane is likely to provide stable balancing power to an external power supply.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an overall configuration of a power supply system according to an embodiment of the present disclosure;

FIG. 2 shows the configurations of a vehicle, server, and power supply equipment shown in FIG. 1;

FIG. 3 is a flowchart of a process related to power supply that is performed by the vehicle, server, and power supply equipment shown in FIG. 2;

FIG. 4 illustrates arrangement of the power supply equipment according to the embodiment of the present disclosure;

FIG. 5 is a plan view showing an overall configuration of a road shown in FIG. 4;

FIG. 6 is a flowchart of a process related to market trading that is performed by a vehicle management device shown in FIG. 1;

FIG. 7 is a flowchart of a process related to monitoring of the supply and demand balance that is performed by the vehicle management device shown in FIG. 1;

FIG. 8 is a flowchart of a power balancing method according to the embodiment of the present disclosure;

FIG. 9 is a flowchart showing details of power balancing shown in FIG. 8;

FIG. 10 shows a modification of a method for selecting a substitute vehicle; and

FIG. 11 shows a modification of the road shown in FIG. 5.

### DETAILED DESCRIPTION OF EMBODIMENTS

Hereinafter, an embodiment of the present disclosure will be described in detail with reference to the drawings. The same or corresponding portions are denoted by the same signs throughout the drawings, and description thereof will not be repeated.

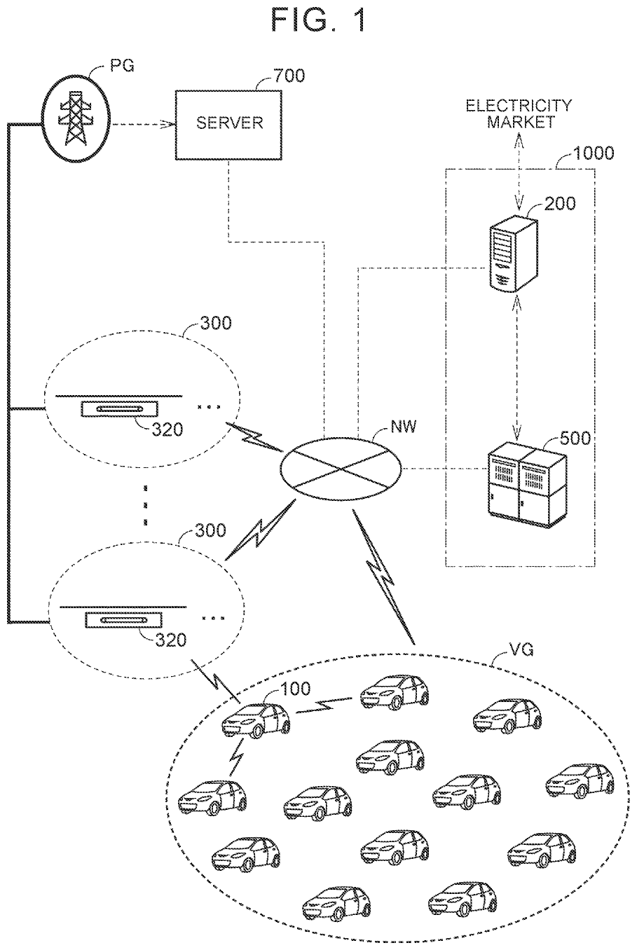

FIG. 1 shows an overall configuration of a power supply system according to an embodiment of the present disclosure. Referring to FIG. 1, the power supply system includes a vehicle management device 1000 and a plurality of pieces of power supply equipment (hereinafter, each piece of power supply equipment will be referred to as “power supply equipment 300” when not individually identified). The vehicle management device 1000 includes a server 200 and a server 500 that can communicate with each other. The server 200 is a computer that belongs to an aggregator (hereinafter sometimes referred to as “aggregator server”).

A power grid PG is a power network formed by power transmission and distribution equipment. A plurality of power plants is connected to the power grid PG. Electric power is supplied from the power plants to the power grid PG. In the present embodiment, an electric power company maintains and manages the power grid PG (commercial power supply). The electric power company is a general power transmission and distribution operator and is also a transmission system operator (TSO). The power grid PG supplies alternate current (AC) power (e.g., three-phase AC power). A server 700 is a computer that belongs to the TSO (hereinafter sometimes referred to as “TSO server”). The server 700 may include a central load dispatching center system and a simple command system. The server 200 and the server 700 are configured to communicate with each other via a communication network NW. The power grid PG according to the present embodiment is an example of the “external power supply” according to the present disclosure.

The server 500 is configured to manage a vehicle group VG. The vehicle group VG includes a plurality of vehicles configured to use the power supply equipment 300. The server 500 is configured to periodically communicate with each vehicle in the vehicle group VG. The number of vehicles in the vehicle group VG may be 10 or more and less than 100, 100 or more and less than 500, or 500 or more. It is assumed in the present embodiment that the vehicle group VG includes about 200 vehicles. Hereinafter, each vehicle in the vehicle group VG will be referred to as “vehicle 100” not individually identified. The vehicle 100 is a vehicle managed by the vehicle management device 1000 (managed vehicle).

The power supply equipment 300 includes a power transmission coil 320 installed in a road. The vehicle 100 is configured to be supplied with power from the power supply system (more specifically, the power transmission coil 320). The vehicle 100 is configured to communicate with each of the servers 200, 500 via the communication network NW. The communication network NW is a wide area network formed by, for example, the Internet and wireless base stations. Each of the servers 200, 500 is connected to the communication network NW via, for example, a communication line. The servers 200, 500 may directly communicate with each other without using the communication network NW, or may communicate with each other via the communication network NW. The power supply equipment 300 is configured to wirelessly communicate with the vehicle 100. The vehicles 100 in the vehicle group VG may be configured to perform vehicle-to-vehicle communication (V2V communication) with each other. In the present embodiment, the power supply equipment 300 accesses the communication network NW by wireless communication, and communicates with the server 200 via the communication network NW. However, the present disclosure is not limited to this form, and the server 200 and the power supply equipment 300 may be directly connected by a communication line and communicate with each other without using the communication network NW.

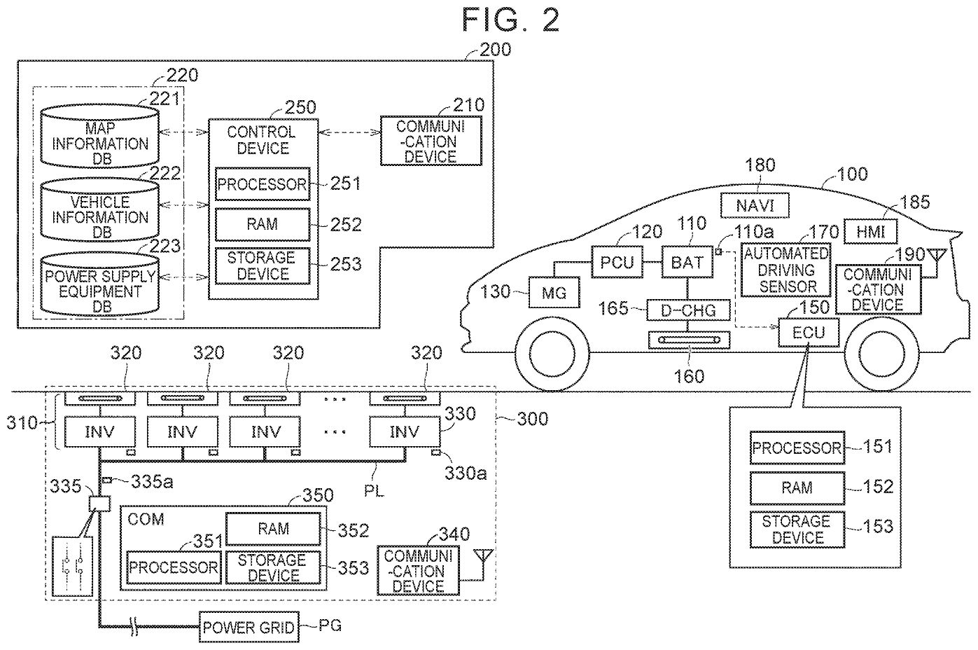

The vehicle 100 has a configuration shown in FIG. 2 described below. The vehicle 100 is an example of an object (power supply target) to which the power supply equipment 300 supplies power in the power supply system. FIG. 2 shows the configurations of the vehicle 100, the server 200, and the power supply equipment 300.

Referring to FIG. 2, the vehicle 100 includes a battery 110, a monitoring module 110a, a power control unit (PCU) 120, a motor generator hereinafter referred to as “MG”) 130, an electronic control unit (hereinafter referred to as “ECU”) 150, a power receiving coil 160, a charger and discharger (D-CHG) 165, an automated driving sensor 170, a navigation system (hereinafter referred to as “NAVI”) 180, and a Human Machine Interface (HMI) 185, and a communication device 190.

The ECU 150 includes a processor 151, a random access memory (RAM) 152, and a storage device 153. The processor 151 may be a central processing unit (CPU). The RAM 152 functions as a working memory for temporarily storing data to be processed by the processor 151. The storage device 153 is configured to save stored information. The storage device 153 stores, in addition to a program, information to be used in the program (e.g., maps, mathematical formulas, and various parameters). In the present embodiment, various controls in the vehicle 100 are performed by the processor 151 executing the program stored in the storage device 153. However, the present disclosure is not limited to this, and various controls may be performed by dedicated hardware (electronic circuit).

The vehicle 100 includes a battery 110 that stores electric power for moving the vehicle 100. The vehicle 100 is configured to move using the electric power stored in the battery 110. The vehicle 100 according to the present embodiment is a battery electric vehicle (BEV) without an engine (internal combustion engine). The battery 110 can be a known energy storage device for vehicles (e.g., a liquid secondary battery, an all-solid-state secondary battery, or an assembled battery). Examples of a secondary battery for vehicles include a lithium-ion battery and a nickel metal hydride battery. The monitoring module 110a includes various sensors for detecting the state of the battery 110 (e.g., voltage, current, and temperature), and outputs the detection results to the ECU 150. The monitoring module 110a may be a battery management system (BMS) having a state of charge (SOC) estimation function, a state of health (SOH) estimation function, a cell voltage equalization function, a diagnostic function, and a communication function, in addition to the above sensor function. The ECU 150 can acquire the state of the battery 110 (e.g., temperature, current, voltage, SOC, and internal resistance) based on the output of the monitoring module 110a. The SOC indicates the remaining capacity of the energy storage device. For example, the SOC is the ratio of the available capacity to the capacity in the fully charged state and varies between 0% and 100%.

The PCU 120 is configured to include, for example, an inverter, a converter, and a relay (hereinafter referred to as “system main relay (SMR)”). The PCU 120 is controlled by the ECU 150. The MG 130 is, for example, a three-phase AC motor generator. The MG 130 is driven by the PCU 120 and is configured to rotate drive wheels of the vehicle 100. The PCU 1120 drives the MG 130 using the electric power supplied from the battery 110. The MG 130 is configured to generate regenerative electric power and supply the generated electric power to the battery 110. Any desired number of motors (MGs) for traction may be used. The number of motors (MGs) may be one, two, or three or more. The motor for traction may be an in-wheel motor. The SMR is configured to connect and disconnect the electric circuit from the battery 110 to the MG 130. The SMR is closed (connected state) when the vehicle 100 is traveling.

In the present embodiment, the power receiving coil 160 is mounted in a lower part of a vehicle body (e.g., under the floor) of the vehicle 100. The position of the power receiving coil can be changed as appropriate, and the power receiving coil may be mounted near a wheel, The power receiving coil 160 is configured to perform wireless power transfer (that is, contactless power transfer) to and from the power transmission coil 320 of the power supply system. Any desired method can be used as a wireless power transfer (WPT) method, such as a magnetic field resonance method or an electromagnetic induction method. Other methods may be used. The charger and discharger 165 is located in the electric circuit from the power receiving coil 160 to the battery 110. The charger and discharger 165 is configured to convert the electric power supplied from the power supply system to the power receiving coil 160 to electric power suitable for charging the battery 110. The charger and discharger 165 is also configured to convert the electric power of the battery 110 to electric power suitable for external discharge (discharging to the outside of the vehicle 100).

The charger and discharger 165 includes, for example, an alternate current to direct current (AC-to-DC) converter circuit that performs bidirectional power conversion, and a charge and discharge relay that connects and disconnects the electric circuit from the power receiving coil 160 to the battery 110. The AC-to-DC converter circuit converts the AC power received from the power receiving coil 160 to direct current (DC) power and outputs the DC power to the battery 110. The AC-to-DC converter circuit also converts the DC power received from the battery 110 to AC power and outputs the AC power to the power receiving coil 160. The charger and discharger 165 may further include a direct current to direct current (DC-to-DC) converter and a filter circuit. The charge and discharge relay is controlled by the ECU 150. The charge and discharge relay is basically open (disconnected state), but is closed (connected state) when the battery 110 is charged with the electric power received by the power receiving coil 160. The charge and discharge relay is also closed (connected state) when external discharge is performed through the power receiving coil 160.

The vehicle 100 is configured to be charged while traveling. Charging of the vehicle 100 while traveling is the type of charging in which the electric power from the power supply system (more specifically, the power transmission coil 320) is input to the battery 110 via the power receiving coil 160 and the charger and discharger 165 while the vehicle 100 is traveling. When charging while traveling is performed, the charge and discharge relay is closed while the vehicle 100 is traveling.

The vehicle 100 is an automated driving vehicle configured to perform automated driving. The vehicle 100 according to the present embodiment is configured to perform both manned driving (travel with an occupant(s) in the vehicle 100) and unmanned driving (travel with no occupant in the vehicle 100). Although the vehicle 100 is configured to perform unmanned autonomous driving, the vehicle 100 can also be manually driven by a user (manned driving). The vehicle 100 may be configured to travel in a platoon.

The automated driving sensor 170 is a sensor used for automated driving. The automated driving sensor 170 may be used in predetermined control when automated driving is not being performed. The automated driving sensor 170 includes a sensor that acquires information for perceiving the outside environment of the vehicle 100 (hereinafter also referred to as “outside environment sensor”), a sensor that acquires information for perceiving the in-vehicle environment of the vehicle 100 (hereinafter also referred to as “in-vehicle environment sensor”), and a sensor that acquires information on the behavior of the vehicle 100 (hereinafter also referred to as “behavior sensor”). The detection results of each sensor are output to the ECU 150.

The outside environment sensor is, for example, at least one of the following sensors: a camera, millimeter-wave radar, and light detection and ranging (LiDAR) sensor facing the outside of the vehicle. The ECU 150 can perceive the outside environment of the vehicle 100 based on the output of the outside environment sensor. The in-vehicle environment sensor is, for example, either or both of a camera and infrared sensor facing the inside of the vehicle. The ECU 150 can determine whether the vehicle 100 is manned or unmanned, based on the output of the in-vehicle environment sensor. The automated driving sensor 170 may include a seating sensor or a seatbelt sensor as the in-vehicle environment sensor. The behavior sensor is, for example, either or both of an Inertial Measurement Unit (IMU) and a Global Positioning System (GPS) sensor. The UPS sensor is a position sensor using UPS. The automated driving sensor 170 may include at least one of the following sensors as the behavior sensor: a vehicle speed sensor, an acceleration sensor, and a yaw rate sensor. The ECU 150 can detect or predict the position and attitude (current state or future state) of the vehicle 100 based on the output of the behavior sensor.

The NAVI 180 includes a UPS module and a storage device. The storage device stores map information. The GPS module is configured to receive signals from GPS satellites, not shown (hereinafter referred to as “UPS signals”). The NAVI 180 can identify the position of the vehicle 100 using the GPS signals. The NAVI 180 is configured to perform a route search for finding an optimal route (e.g., the shortest route) from the current position of the vehicle 100 to the destination by referring to the map information. The NAVI 180 may wirelessly communicate with a data center to sequentially update the map information. The user can set a travel plan on the NAVI 180. When a travel plan is set on the NAVI 180, the travel plan is transmitted from the vehicle 100 to the server 500. The travel plan may include at least one of the following items: a travel route, a destination, and a travel schedule (e.g., the arrival time for each set location).

The HMI 185 includes an input device and a display device. The HMI 185 may include a touch panel display. The HMI 185 may include a smart speaker that receives voice input. The HMI 185 may display various kinds of information input from the user and various kinds of information acquired from the outside of the vehicle 100 (e.g., from the server 200). The HMI 185 may display a route found by the NAVI 180.

The ECU 150 performs various controls related to traveling of the vehicle 100 (e.g., drive control, braking control, and steering control). The ECU 150 is configured to perform automated driving according to a predetermined automated driving program. The ECU 150 may perform automated driving according to the travel route and travel schedule set on the NAVI 180 by controlling an accelerator device, brake device, and steering device (none of which are shown) of the vehicle 100 using various kinds of information acquired by the automated driving sensor 170. The automated driving program may be sequentially updated by Over the Air (OTA).

The communication device 190 includes a long-range communication module and a short-range communication module. The long-range communication module is a communication interface (I/F) for long-range communication. The long-range communication module includes, for example, a Data Communication Module (DCM). The long-range communication module may include a communication I/F compatible with either or both of the 5th generation mobile communication system (5G) and WiMAX (registered trademark). The long-range communication module is configured to access the communication network NW (wide area network) shown in FIG. 1. The vehicle 100 (ECU 150) is configured to access the communication network NW by the long-range communication module and wirelessly communicate with the server 200 via the communication network NW.

The short-range communication module is a communication I/F for short-range communication. The communication distance of the short-range communication is shorter than that of the long-range communication. The communication distance of the short-range communication module may be less than 200 m, or may be 1 m or more and 30 m or less. Examples of the short-range communication include communication by wireless Local Area Network (LAN), Bluetooth (registered trademark), and ZigBee (registered trademark). The short-range communication may use either or both of Radio Frequency Identification (RFID) and dedicated Short Range Communication (DSRC). The vehicle 100 (ECU 150) is configured to perform short-range wireless communication with the power supply equipment 300 (more specifically, a communication device 340 that will be described later) by the short-range communication module.

The communication device 190 may further include at least one of the following communication modules: a communication module that performs vehicle-to-vehicle (V2V) wireless communication, a communication module that performs vehicle-to-roadside infrastructure (V2I) wireless communication, and a communication module that performs wireless communication with a terminal brought into the vehicle (e.g., a smartphone or a wearable device).

The power supply equipment 300 includes a plurality of power transmission coils 320 installed in a road, power converter circuits 330 provided for each power transmission coil 320, monitoring modules 330a provided for each power converter circuit 330, a power supply relay 335, a communication device 340, a computer (hereinafter referred to as “COM”) 350, and a power supply line PL. The power supply equipment 300 may include any desired number of power transmission coils 320.

The power transmission coils 320 and the power converter circuits 330 that are installed in the road form a power supply circuit 310 that supplies power to a vehicle that is traveling on the road. Each monitoring module 330a includes a power supply sensor for detecting input and output power of a corresponding one of the power converter circuits 330. Each power converter circuit 330 is electrically connected to a corresponding one of the power transmission coils 320. Each power converter circuit 330 included in the power supply circuit 310 is electrically connected to the power supply line PL. The power supply line PL is electrically connected to the power grid PG via the power supply relay 335.

The COM 350 includes a processor 351 (e.g., CPU), a RAM 352, and a storage device 353. The storage device 353 stores, in addition to a program, information to be used in the program (e.g., maps, mathematical formulas, and various parameters). As will be described in detail later, when the power supply equipment 300 is reserved for power supply, information on the vehicle that has reserved the power supply equipment 300 for power supply (e.g., identification information) is stored in the storage device 353. In the present embodiment, various controls in the power supply equipment 300 are performed by the processor 351 executing the program stored in the storage device 353. However, the present disclosure is not limited to this, and various controls may be performed by dedicated hardware (electronic circuit).

The power converter circuit 330 includes, for example, an inverter (INV) that performs bidirectional power conversion. The power supply relay 335 is configured to connect and disconnect a power supply path. The power converter circuits 330 and the power supply relay 335 are controlled by the COM 350. The power supply relay 335 is basically open (disconnected state), but is closed (connected state) when WPT is performed by the power transmission coil 320. In WPT from the power supply equipment 300 to a vehicle (power supply lane), the power converter circuit 330 is supplied with electric power from the power supply line PL to generate electric power for WPT and output the generated electric power to the power transmission coil 320. The power converter circuit 330 reversely supplies electric power to the power grid PG by converting electric power received by the power transmission coil 320 by WPT from a vehicle (power supply lane) to the power supply equipment 300 to electric power suitable for the power supply line PL.

Each monitoring module 330a includes various sensors for detecting the state of a corresponding one of the power converter circuits 330 (e.g., a current sensor, a voltage sensor, and a temperature sensor), and outputs the detection results to the COM 350. The monitoring module 330a is configured to detect each of the output power of the power converter circuit 330 to be supplied to the vehicle on the road via the power transmission coil 320 and the input power of the power converter circuit 330 to be input from the vehicle on the road to the power converter circuit 330 via the power transmission coil 320. Specifically, each monitoring module 330a includes a current sensor and a voltage sensor for detecting the input and output power of a corresponding one of the power converter circuits 330.

The power supply line PL is provided with a watt-hour meter 335a. The watt-hour meter 335a measures a change in total value of the input power and output powers of all the power converter circuits 330 included in the power supply equipment 300. The balancing amount (ΔkW) of a corresponding one of the pieces of power supply equipment is measured by the watt-hour meter 335a. The watt-hour meter 335a may be a smart meter. The watt-hour meter 335a measures the electric energy at predetermined time intervals, stores the measured electric energy, and transmits the measured electric energy to the server 200.

Like the communication device 190 described above, the communication device 340 includes a long-range communication module and a short-range communication module, The power supply equipment 300 (COM 350) is configured to access the communication network NW by the long-range communication module and wirelessly communicate with the server 200 via the communication network NW. The power supply equipment 300 (COM 350) is configured to perform short-range wireless communication with the vehicle 100 (more specifically, the communication device 190) by the short-range communication module. Therefore, when the vehicle 100 approaches the power supply equipment 300, information can be transferred between the vehicle 100 and the power supply equipment 300 by short-range wireless communication.

The server 200 includes a communication device 210, a database 220, and a control device 250. The communication device 210 is configured to communicate with each of the vehicle 100 and the power supply equipment 300 through the communication network NW. The control device 250 is configured to bidirectionally exchange information with each of the power supply equipment 300 (COM 350) and the vehicle 100 (ECU 150).

The control device 250 includes a processor 251 (e.g., CPU), a RAM 252, and a storage device 253. The storage device 253 stores, in addition to a program, information to be used in the program (e.g., maps, mathematical formulas, and various parameters). In the present embodiment, various controls in the server 200 are performed by the processor 251 executing the program stored in the storage device 253. However, the present disclosure is not limited to this, and various controls may be performed by dedicated hardware (electronic circuit).

The database 220 includes a map information database 221, a vehicle information database 222, and a power supply equipment database 223. Hereinafter, the term “database” will be referred to as “DB.”

The vehicle information DB 222 stores information on each vehicle registered in the server 200. In the present embodiment, the plurality of vehicles 100 included in the vehicle group VG (FIG. 1) is registered in the server 200, and information on the vehicles 100 is managed by the vehicle information DB 222. The vehicle information DB 222 individually manages information on each vehicle (hereinafter also referred to as “vehicle information”) in association with information identifying the vehicle (hereinafter also referred to as “vehicle identification (ID)”). For example, the vehicle information includes: information indicating the specifications of the vehicle (e.g., model, full charge capacity, rated charge power, and rated discharge power); the state of the vehicle system (in operation, stopped, occurrence of abnormality, etc.); the position of the vehicle; the driving condition (manned driving, unmanned driving, vehicle speed, etc.); a travel plan (e.g., destination); information on automated driving (e.g., target value of driving control); the state of the energy storage device (e.g., SOC); information on a power supply request (whether there is a request, requested power, etc.); information on a charging fee; and information on the performance of power balancing (e.g., incentive and penalty according to the performance of power balancing).

The power supply equipment DB 223 stores information on each piece of power supply equipment registered in the server 200. In the present embodiment, the plurality of pieces of power supply equipment 300 is registered in the server 200, and information on the pieces of power supply equipment 300 is managed by the power supply equipment DB 223. The power supply equipment DB 223 individually manages information on each piece of power supply equipment (hereinafter also referred to as “equipment information”) in association with information identifying the piece of power supply equipment (hereinafter also referred to as “equipment ID”). For example, the equipment information includes: information indicating the specifications of the power supply equipment (e.g., manufacturer, model number, power supply method, and rated output power); information on the position of the power supply equipment; information on the power supply performance (e.g., vehicle ID to which electric power is to be supplied); and maintenance information (e.g., time for inspection, time for parts replacement, and usage history).

The map information DB 221 stores map information. The map information indicates various roads in a predetermined area. The control device 250 may grasp the positions of the vehicles and the pieces of power supply equipment on the map by referring to the map information DB 221, the vehicle information DB 222, and the power supply equipment DB 223. The server 200 may further acquire traffic congestion information and weather information in each area from the outside. The traffic congestion information and the weather information may be provided on the communication network NW by, for example, a known service. The map information DB 221, the vehicle information DB 222, and the power supply equipment DB 223 are updated with the latest information periodically or at a predetermined timing. In the present embodiment, the server 500 sequentially receives predetermined vehicle information (e.g., the position of the vehicle, the driving condition, and the state of the energy storage device) from each vehicle included in the vehicle group VG. The server 200 may request the vehicle information to the server 500 and update the vehicle information DB 222 with the latest vehicle information received from the server 500, as necessary.

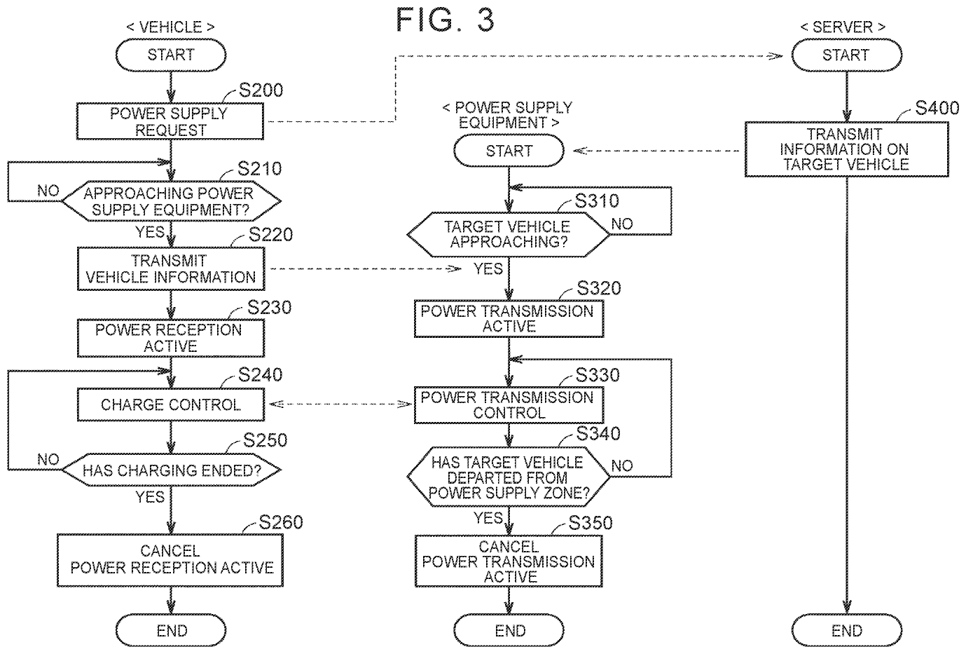

In the power supply system shown in FIG. 1, the power supply equipment 300 is configured to contactlessly supply electric power to the moving vehicle 100. FIG. 3 is a flowchart of a process that is performed by the vehicle 100, the power supply equipment 300, and the server 200 when the vehicle 100 is supplied with electric power from the power supply equipment 300. In the following description, the term “step” in the flowchart is abbreviated as “S.”

Referring to FIG. 3 together with FIGS. 1 and 2, in S200, the vehicle 100 (ECU 150) sends a power supply request to the server 200. The power supply request (S200) is fulfilled when a predetermined condition (hereinafter referred to as “power supply start condition”) is satisfied. For example, the power supply start condition may be satisfied when the user enters a predetermined input (input requesting power supply) to the HMI 185 during manned driving of the vehicle 100.

in the power supply request (S200), the ECU 150 transmits a predetermined power supply request signal to the server 200. The power supply request signal includes the identification information (vehicle ID) of the vehicle 100 and the requested power (kW). The ECU 150 may specify the power supply equipment to which the vehicle 100 requests power supply and send a power supply request. In this case, the ECU 150 transmits a power supply request signal including information specifying the power supply equipment (e.g., equipment ID and/or position) to the server 200. Hereinafter, the vehicle 100 having sent a power supply request to the server 200 will be referred to as “target vehicle.”

When the server 200 receives the power supply request signal from the target vehicle, the server 200 performs S400. In S400, the control device 250 identifies the power supply equipment to which the target vehicle requests power supply, and transmits a predetermined power supply reservation signal to the identified power supply equipment. In the case where the power supply equipment is not specified by the power supply request signal, the control device 250 may specify the power supply equipment to which the target vehicle requests power supply by using the vehicle information of the target vehicle (e.g., the position of the vehicle, a travel plan, and the SOC of the battery 110). The control device 250 may transmit a power supply reservation signal to, for example, one or more pieces of power supply equipment located on the planned travel route of the target vehicle. In this case, the position information of the power supply equipment reserved for power supply may be transmitted from the server 200 to the target vehicle, and a travel route including that power supply equipment may be set on the NAVI 180 of the target vehicle. When the travel route including the reserved power supply equipment is set on the NAVI 180, the target vehicle may start automated driving toward the reserved power supply equipment along the travel route.

The power supply reservation signal includes information on the target vehicle (e.g., vehicle ID and requested power). The control device 250 may add the vehicle information extracted from the vehicle information DB 222 based on the vehicle ID indicated by the power supply request signal to the power supply reservation signal. In the following description, the power supply equipment reserved for power supply (that is, the power supply equipment to which the server 200 has transmitted the power supply reservation signal) will be referred to as “target equipment.” In the present embodiment, the power supply equipment 300 shown in FIG. 2 is the target equipment.

When the target equipment (power supply equipment 300) receives the power supply reservation signal, the vehicle information (e.g., vehicle ID and requested power) included in the power supply reservation signal is registered in the target equipment, the target equipment performs S310. In the case where the server 200 has transmitted the power supply reservation signal to a plurality of pieces of power supply equipment 300, each of the pieces of target equipment (power supply equipment 300) performs a series of steps (S310 to S350) shown in FIG. 3. When one piece of power supply equipment 300 receives power supply reservation signals from a plurality of vehicles 100, the target equipment (power supply equipment 300) performs the series of steps (S310 to S350) shown in FIG. 3 for each target vehicle.

In S310, the COM 350 of the target equipment determines whether the target vehicle is approaching the communication device 340 of the target equipment installed in the road. The communication device 340 is configured to perform short-range communication with the vehicle 100. Hereinafter, the range in which the target equipment can perform short-range communication will also be referred to as “power supply zone.” When the vehicle 100 is present in the power supply zone, it means that the vehicle 100 is approaching the target equipment (including the power supply circuit 310 and the communication device 340). When the COM 350 receives the vehicle ID of the target vehicle from the target vehicle by short-range communication, the COM 350 determines in S310 that the target vehicle is approaching (YES in S310). The COM 350 repeatedly performs S310 as long as the target vehicle is not approaching (NO in S310). In the case where the approach of the target vehicle is not detected even a predetermined time after the reservation for power supply (reception of the power supply reservation signal), the COM 350 may terminate the series of steps shown in FIG. 3 due to a timeout and cancel the reservation.

When the target vehicle (vehicle 100) approaches the target equipment (YES in S210) after the transmission of the power supply request signal (S200), short-range communication between the target equipment and the target vehicle is started. In S220, the ECU 150 of the target vehicle transmits a predetermined power supply start signal to the target equipment by short-range communication. The power supply start signal includes the identification information (vehicle ID) of the target vehicle. When the short-range communication between the target equipment and the target vehicle continues, it means that the target vehicle is present in the power supply zone of the target equipment.

When the target equipment (power supply equipment 300) receives the power supply start signal, the COM 350 of the target equipment checks the vehicle ID registered by the power supply reservation signal against the vehicle ID included in the power supply start signal. When these vehicle IDs match, the COM 350 determines in S310 that the target vehicle is approaching (YES in S310), and the routine proceeds to S320. In S320, the COM 350 sets the power supply circuit 310 to a power transmission active state (state in which WPT is enabled). Electric power is thus supplied from the power converter circuit 330 to the power transmission coil 320. The power supply relay 335 is kept closed (connected state) during power transmission. WPT from the target equipment to the vehicle 100 is performed when the power receiving coil 160 of the vehicle 100 is present over the power transmission coil 320. The COM 350 may control the power supply circuit 310 and the power supply relay 335 so that power transmission is started at the timing the vehicle 100 passes the target equipment after authentication using the vehicle ID. Subsequently, the COM 350 performs power transmission control in S330. Specifically, the COM 350 controls the power converter circuit 330 (inverter) so that the electric power equivalent to the requested power of the target vehicle is supplied to the power transmission coil 320. The value of the supplied electric power detected by the monitoring module 330a during power supply is sequentially recorded together with its acquisition time in the storage device 353.

The ECU 150 of the target vehicle sets the charger and discharger 165 to a power reception active state (state in which charging while traveling is enabled) in S230 after transmitting the power supply start signal (S220). As a result, the charge and discharge relay is closed (connected state), and the electric power from the target equipment (power supply equipment 300) is input to the battery 110 via the power receiving coil 160 and the charger and discharger 165 of the target vehicle. Subsequently, the ECU 150 performs charge control for the battery 110 in S240. Specifically, the ECU 150 controls the charger and discharger 165 so that the electric power (charge power) input to the battery 110 becomes closer to the requested power (kW). The ECU 150 also controls vehicle speed control for the target vehicle based on the requested electric energy (kWh). The lower the vehicle speed of the target vehicle, the greater the electric energy input to the battery 110. The ECU 150 can calculate the received electric power (kW) from the target equipment and the received electric energy (kWh), namely the received electric power integrated with respect to time, by using the detected values of the voltage and current of the battery 110.

In the subsequent step S250, the ECU 150 of the target vehicle determines whether charging of the battery 110 has ended. For example, when the charged energy reaches the requested electric energy or when the battery 110 is fully charged, the ECU 150 of the target vehicle determines that charging has ended. When short-range communication with the target equipment is interrupted (that is, when the target vehicle has left the power supply zone), the ECU 150 of the target vehicle determines that charging has ended. Charging of the battery 110 is performed in S240 as long as charging has not ended (NO in S250).

When charging has ended (YES in S250), the ECU 150 of the target vehicle cancels the power reception active state of the charger and discharger 165 in S260. As a result, the charger and discharger 165 is stopped, and the charge and discharge relay is opened (disconnected state). The charging process in the target vehicle ends when S260 is performed.

The COM 350 of the target equipment determines in S340 whether the target vehicle has departed from the power supply zone, and performs power transmission in S330 while the target vehicle is present in the power supply zone (NO in S340). When the target vehicle has departed from the power supply zone (YES in S340), the COM 350 cancels the power transmission active state of the power supply circuit 310 in S350. As a result, the power converter circuit 330 (inverter) is stopped, and supply of electric power to the power transmission coil 320 is stopped. The power supply relay 335 may be opened (disconnected state) in S350, or may be kept closed (connected state) in preparation for the next vehicle. The power transmission process in the target equipment ends after S350 is performed.

In the present embodiment, the power supply equipment 300 detects the approach of the vehicle 100 based on whether short-range communication between the vehicle 100 and the power supply equipment 300 is established. However, the method for detecting the approach of a vehicle is not limited to this method, and any desired method can be used. For example, the approach of a vehicle may be detected by a sensor installed on or around the road.

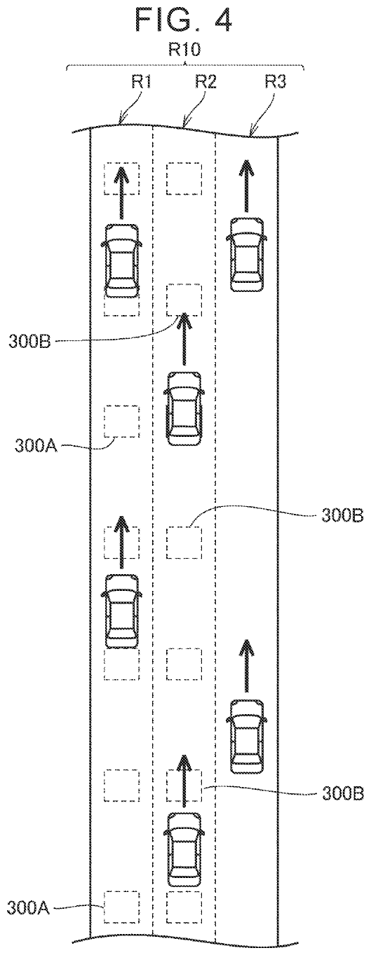

FIG. 4 illustrates arrangement of the power supply equipment according to the present embodiment. Referring to FIG. 4, a road R10 includes three travel lanes R1 to R3. Each of the travel lanes R1, R2 is a power supply lane, and the travel lane R3 is a no-power-supply lane. The travel lane R2 is located between the travel lanes R1, R3. In the present embodiment, the power supply lanes (travel lanes R1, R2) and the no-power-supply lane (travel lane R3) are located on the same road R10.

The power supply system according to the present embodiment includes a plurality of pieces of power supply equipment 300A and a plurality of pieces of power supply equipment 300B that are embedded in the road R10. The pieces of power supply equipment 300A are arranged at predetermined intervals in the travel lane R1. The pieces of power supply equipment 300B are arranged at predetermined intervals in the travel lane R2. The interval between the pieces of power supply equipment 300A in the travel lane R1 and the interval between the pieces of power supply equipment 300B in the travel lane R2 may be either the same or different from each other. Each of the power supply equipment 300A and the power supply equipment 300B has the same configuration as the power supply equipment 300 shown in FIG. 2. The power supply equipment 300A is configured to be supplied with electric power from the power grid PG and supply electric power to a vehicle traveling in the travel lane R1. The power supply equipment 300B is configured to be supplied with electric power from the power grid PG and supply electric power to a vehicle traveling in the travel lane R2. Each of the travel lanes R1, R2 is an example of the “travel lane” according to the present disclosure. Each of the power supply equipment 300A and the power supply equipment 300B is an example of the “power supply equipment” according to the present disclosure.

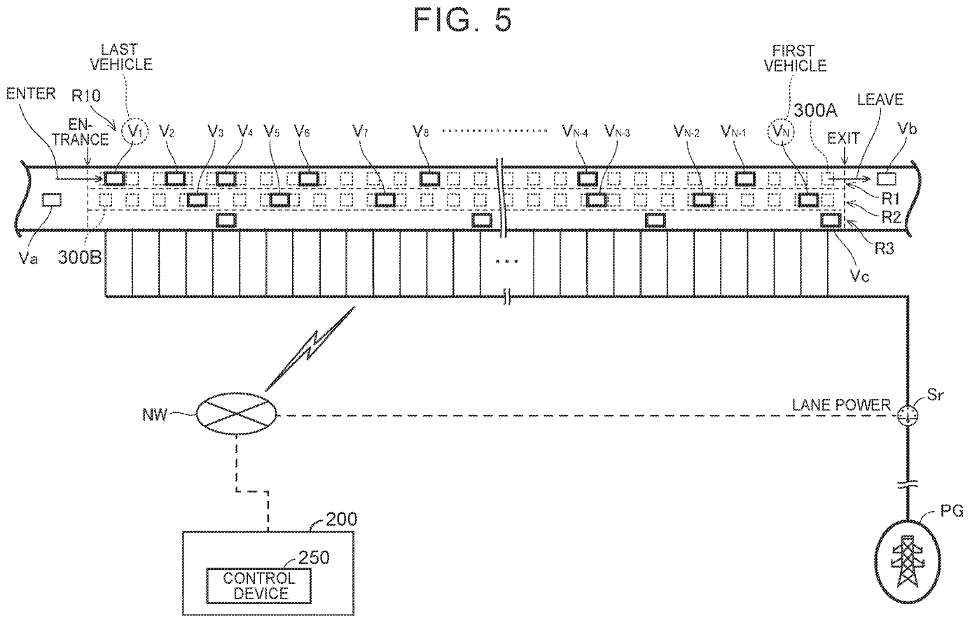

FIG. 5 is a plan view showing an overall configuration of the road R10 shown in FIG. 4. Referring to FIG. 5 together with FIGS. 1 and 2, the road Rio has an entrance and exit for the power supply lanes. The power supply lanes (travel lanes R1, R2) are provided in the area from the entrance to the exit on the road R10. In the example shown in FIG. 5, each vehicle traveling on the road R10 is a vehicle 100 (FIG. 2) included in the vehicle group VG (FIG. 1). The control device 250 of the server 200 is configured to communicate with each of the vehicles 100 traveling on the road R10 and each of the pieces of power supply equipment 300A, 300B via the communication network NW. Of the vehicles 100 traveling on the road R10, the vehicles 100 traveling in the power supply lane will also be referred to as “power supply lane vehicles.”

The vehicles traveling in either the travel lane R1 or R2 are power supply lane vehicles. In the example shown in FIG. 5, there are N power supply lane vehicles on the power supply lanes (travel lanes R1, R2). In FIG. 5, these power supply lane vehicles are denoted by V₁, V₂, V₃, V₄, . . . , V_{N-3}, V_{N-2}, V_{N-1}, and V_{N}. The subscript after the letter “V” indicates the position of the power supply lane vehicle counted from the last power supply lane vehicle. For example, V₅ is the fifth power supply lane vehicle from the last power supply lane vehicle. A vehicle Va before the entrance of the power supply lane is not a power supply lane vehicle. A vehicle Vb having passed the exit of the power supply lane is not a power supply lane vehicle, either. A vehicle traveling in the travel lane R3 (no-power-supply lane) (e.g., a vehicle Vc) is not a power supply lane vehicle, either.

A watt-hour meter Sr is provided between the power grid PG and the power supply lanes (travel lanes R1, R2) of the road R10. The watt-hour meter Sr measures a change in total value of the input and output powers of all the pieces of power supply equipment (all the pieces of power supply equipment 300A, 300B) installed in the power supply lanes of the road R10. The watt-hour meter Sr sequentially measures and sequentially records each of the total power to be input from the power grid PG to the power supply lanes of the road R10 and the total power to be output from the power supply lanes of the road R10 to the power grid PG. The balancing amount (ΔkW) by the power supply lanes of the road R10 is measured by the watt-hour meter Sr. The watt-hour meter Sr may be a smart meter. The watt-hour meter Sr measures the electric energy at predetermined time intervals, stores the measured electric energy, and transmits the measured electric energy to the server 200. Hereinafter, the electric power detected by the watt-hour meter Sr will also be referred to as “lane power.”

When a balancing power request is generated (that is, when power balancing of the power grid PG is requested), the control device 250 of the server 200 performs vehicle selection in which the control device 250 selects balancing vehicles to be controlled for power balancing of the power grid PG (that is, vehicles that are to operate or stand by to provide the balancing power) from the vehicle group VG (FIG. 1). In the present embodiment, the control device 250 is configured to, when any of the selected balancing vehicles stops performing power balancing of the power grid PG using the power supply equipment 300A or 300B halfway through, select a substitute vehicle to be controlled to perform power balancing of the power grid PG in place of the balancing vehicle having stopped performing power balancing halfway through from the vehicles traveling in the power supply lanes of the road R10. In such a power supply system, even when any of the balancing vehicles stops performing power balancing of the power grid PG halfway through, the substitute vehicle performs power balancing of the power grid PG in place of that balancing vehicle. This reduces shortage of the balancing power from the power supply lanes of the road R10. As a result, the power supply lanes are likely to provide stable balancing power to the power grid PG.

In the present embodiment, a balancing power request is generated when the control device 250 wins a bid for the balancing power for the power grid PG on the electricity market. Electricity is traded as products on the electricity market. Each product is bought and sold by, for example, bidding. The balancing power for the power grid PG is also traded on the electricity market. The balancing power gives the power grid PG flexibility (ability to change production or consumption of electric power in response to power fluctuations). Products are traded on a period-by-period basis on the electricity market. A “period” is one of frames of unit time into which one day is divided (hereinafter the “period” will be referred to as “frame”). In the present embodiment, electricity is traded for 48 frames of 30 minutes into which one day is divided. The market closing time for each frame is called “gate close (GC).” In the present embodiment, GC is art hour before the start time of the frame.

An aggregator conducts electronic commerce using the server 200. The server 200 trades the balancing power on the electricity market. Accounting for market trading is managed by the server 200. When the server 200 wins a bid for the balancing power on the electricity market, the server 200 generates a balancing power request corresponding to the won balancing power.

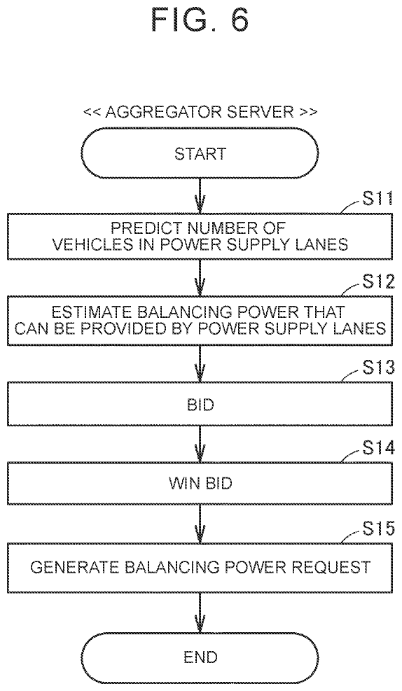

FIG. 6 is a flowchart of a process related to market trading that is performed by the server 200. The process shown in this flowchart is performed when a predetermined condition is satisfied. The predetermined condition may be satisfied either at a predetermined time or periodically. The predetermined condition may be satisfied when the server 200 receives a bid instruction from the user, The server 200 may determine the timing suitable for bidding based on at least one of the following pieces of information: market price, weather information (including weather forecast information), and demand history of the vehicle group VG, and perform the process of FIG. 6 at the timing suitable for bidding. The electricity market is, for example, a spot market (day-ahead market). However, the present disclosure is not limited to this, and the electricity market may be an hour-ahead market (intraday market), a balancing market, or a capacity market.

Referring to FIG. 6 together with FIGS. 1, 2, and 5, in S11, the control device 250 of the server 200 predicts the number of vehicles 100 that will be traveling in the power supply lanes (travel lanes R1, R2) of the road R10 during a predetermined period (e.g., a frame corresponding to each product). Hereinafter, the predetermined period will also be referred to as “target trading period.” The control device 250 may predict this number of vehicles by using the vehicle information (e.g., travel plans) managed by the vehicle information DB 222. The control device 250 may predict this number of vehicles based on the level of traffic congestion in the power supply lanes predicted from traffic information. The server 200 may acquire traffic information through Vehicle Information and Communication System (VICS) (registered trademark).

In the subsequent step S12, the control device 250 predicts the balancing power that can be provided by the power supply lanes (travel lanes R1, R2) of the road R10 during the target trading period by using the number of vehicles 100 predicted in S11. The larger the number of vehicles 100 predicted in S11, the larger the balancing power (upper limit value of the balancing power) that can be provided by the power supply lanes of the road R10 during the target trading period. The control device 250 may predict this balancing power by further using information on the charge and discharge specifications (e.g., at least one of the following values: full charge capacity, rated charge power, and rated discharge power) of each vehicle 100 predicted to be present in the power supply lanes of the road R10 during the target trading period.

In the subsequent step S13, the control device 250 selects a product for trading based on the balancing power predicted in S12, and bids on the selected product. In S14, the control device 250 receives a notification from a market manager that the control device 250 has won the bid product (balancing power). Thereafter, when the start time of the won balancing power (start time of the target trading period) comes, the control device 250 generates a balancing power request corresponding to the won balancing power in S15. As described above, the server 200 is configured to predict the number of vehicles that will be traveling in the power supply lanes during the predetermined period (Sit) and bid on the balancing power for the predetermined period on the electricity market based on the predicted number of vehicles (S13).

When the balancing power request is generated in S15, the server 200 (aggregator) is requested to provide the balancing power during the target trading period. That is, the target trading period is a balancing duration (period during which provision of the balancing power is requested). The aggregator (winning bidder) who has won the bid for the balancing power performs power balancing within the range of the won amount (ΔkW contract amount) with respect to a reference value (kW). The won amount may be positive (upward balancing power) or negative (downward balancing power). The winning bidder notifies the market manager of the reference value by GC (an hour before the start time of the won frame). The market manager is notified in advance of the power supply lanes of the road R10 as resources (e.g., a list pattern) to be used for power balancing. The server 200 performs power balancing using the power supply lanes of the road R10 in one or more won frames (balancing durations). The server 200 controls the lane power (electric power detected by the watt-hour meter Sr) according to, for example, a command from the server 700 (TSO server). In the case where an output command value is changed during the balancing duration, the server 200 changes the output of the power supply lanes (lane power) to that value within the response time of the product requirement. In the case where the output command value remains the same during the balancing duration, the server 200 maintains the output of the power supply lanes (lane power) according to that command for at least the duration of the product requirement. After all the won frames end, the server 200 transmits data on the performance of power balancing for these frames to the server 700.

The aggregator is responsible for achieving balancing of the power grid PG, in addition to the market trading described above. The aggregator is a balance responsible party (BRP). The planned value power balancing system is used in the present embodiment. The aggregator submits a planned value for each frame to a predetermined institution in advance. In the present embodiment, the frame length (unit time) is 30 minutes. The predetermined institution may be Organization for Cross-regional Coordination of Transmission Operators, JAPAN (OCCTO). The deadline for changing planned value (deadline for submitting planned supply and demand values) in the planned value power balancing system is GC (an hour before the frame), and the planned value can o longer be changed after GC. An imbalance (discrepancy from the planned value) regarding balancing is evaluated for each frame. The aggregator that caused an imbalance is obliged to pay an imbalance charge (penalty).

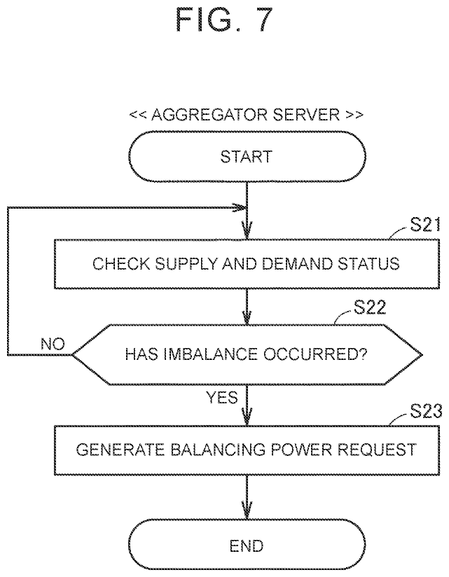

The aggregator monitors the supply and demand balance (balancing) of the power grid PG by using the server 200. FIG. 7 is a flowchart of a process related to monitoring of the supply and demand balance by the server 200. The process shown in this flowchart may be started at the start time of a predetermined frame (frame to be monitored).

Referring to FIG. 7 together with FIGS. 1, 2, and 5, in S21, the control device 250 of the server 200 acquires actual supply and demand in the relationship between the aggregator (more specifically, each resource managed by the aggregator) and the power grid PG. The actual supply and demand may include either or both of the electric energy supplied from the power grid PG to the aggregator and used by the aggregator (electricity demand) and the electric energy supplied from the aggregator to the power grid PG (electricity supply). The actual supply and demand is detected by, for example, a sensor in each resource (including the power supply lanes of the road R10) managed by the aggregator.

In the subsequent step S22, the control device 250 determines whether an imbalance regarding balancing of the power grid PG is greater than a predetermined allowable range in the monitored frame. Steps S21, S22 are repeated while the imbalance is within the allowable range (NO in S22). When the imbalance becomes greater than the allowable range (YES in S22), the control device 250 generates a balancing power request for eliminating the imbalance in S23.

An imbalance regarding balancing is, for example, the difference between the planned supply and demand values and the actual supply and demand values. For example, an imbalance regarding balancing occurs when the demand forecast is wrong and the actual value of demand (power consumption) becomes larger than the planned value. An imbalance regarding balancing also occurs when the power generation forecast (e.g., the forecast of electric power generated by photovoltaic power generation or wind power generation) is wrong and the actual value of supply (generated power) becomes larger than the planned value.

When a balancing power request is generated in S23, the server 200 (aggregator) is requested to provide the balancing power in the monitored frame. That is, the monitored frame (30 minutes) is a balancing duration. The server 200 balances the actual supply and demand using the power supply lanes of the road R10 so that the imbalance with respect to the planned value (kWh) in the monitored frame becomes small enough.

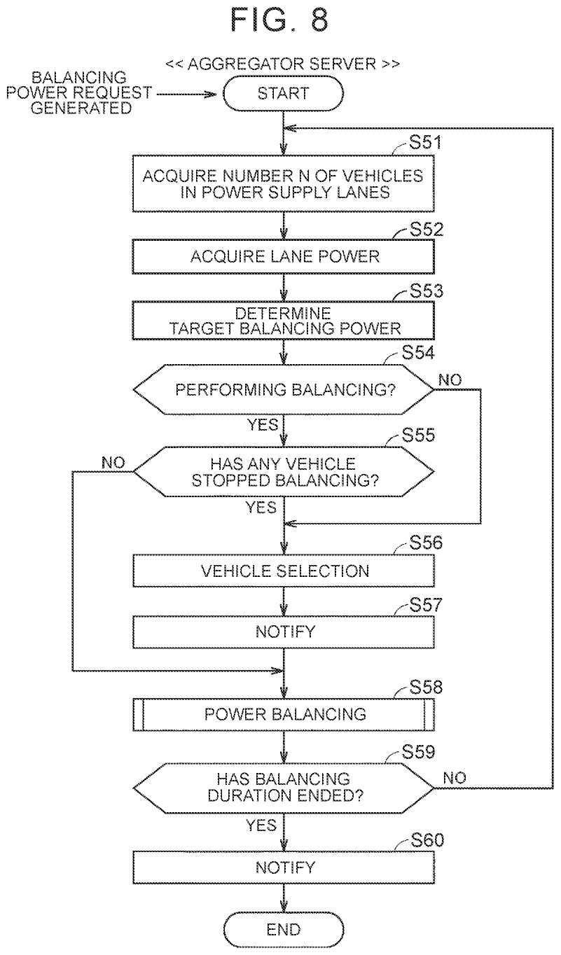

When a balancing power requests generated in S15 of FIG. 6 or S23 of FIG. 7, the server 200 starts a series of steps shown in FIG. 8 described below. FIG. 8 is a flowchart of a power balancing method according to the present embodiment.

Referring to FIG. 8 together with FIGS. 1, 2, and 5, in S51, the control device 250 of the server 200 acquires the number of vehicles 100 traveling in the power supply lanes(travel lanes R1, R2) of the road R10 (hereinafter this number of vehicles 100 will be referred tip as “number N”). FIG. 5 shows an example in which the number N is 10 or more. However, the number N changes from moment to moment according to the entry and exit status of the vehicles 100 to and from the power supply lanes. The number N may be less than 10 depending on the condition of the power supply lanes.

The control device 250 may detect the number N using the vehicle information (e.g., the positions of the vehicles) managed by the vehicle information DB 222. The control device 250 can acquire the latest data from the server 500. The control device 250 may detect the number N using the information acquired from the power supply equipment 300. For example, each piece of power supply equipment (power supply, equipment 300A, 300B) installed in the power supply lanes of the road R10 may sequentially transmit the vehicle ID of each vehicle having passed through that power supply equipment to the server 200 together with the equipment ID of that power supply equipment.

The control device 250 may detect the number N using the information acquired from the road R10 or the vehicles 100 traveling on the road R10. For example, the control device 250 may detect the number N using a sensor or camera (e.g., an N-system (automatic license plate recognition system) or a traffic counter) mounted on the road R10. Alternatively, a first communication device (not shown) mounted near the entrance of the power supply lanes of the road R10 may wirelessly communicate with a vehicle having newly entered the power supply lane. The first communication device may notify this vehicle that this vehicle has entered the power supply lane, receive the vehicle ID from this vehicle (vehicle ID of the last vehicle), and transmit the vehicle ID of the last vehicle to the server 200. A second communication device (not shown) mounted near the exit of the power supply lanes of the road R10 may wirelessly communicate with a vehicle having left the power supply lane. The second communication device may notify this vehicle (exiting vehicle that had been the first vehicle until just before) that this vehicle has left the power supply lane, receive the vehicle ID from this vehicle (vehicle ID of the exiting vehicle), and transmit the vehicle ID of the exiting vehicle to the server 200. The vehicles 100 in the power supply lanes of the road R10 may exchange information (e.g., vehicle ID and vehicle position) with each other by vehicle-to-vehicle communication (V2V communication). Information indicating the surroundings of each vehicle 100 in the power supply lanes may be transmitted from each vehicle 100 to the server 200.

In the subsequent step S52, the control device 250 acquires lane power (power detected by the watt-hour meter Sr). In the subsequent step S53, the control device 250 determines target balancing power based on the lane power and the requested balancing power (magnitude of the balancing power requested by the generated balancing power request). For a balancing power request generated due to a successful bid on the electricity market, the control device 250 may determine target balancing power based on, for example, the requested balancing power indicated by the command from the server 700 (TSO server) and the lane power detected by the watt-hour meter Sr. For a balancing power request generated due to an imbalance regarding balancing, the control device 250 may determine target balancing power based on, for example, the planned value, the actual supply and demand, and the lane power.

In the subsequent step S54, the control device 250 determines whether the power supply lanes of the road R10 are performing power balancing of the power and PG. In the first routine, the control device 250 determines that power balancing of the power grid PG has not been started yet (NO in S54), and the routine proceeds to S56. In S56, the control device 250 selects balancing vehicles (vehicles 100 to be controlled for power balancing of the power grid PG) from the N power supply lane vehicles. In the present embodiment, the control device 250 selects the vehicles 100 capable of dealing with the target balancing power (more specifically, the target balancing power determined based on the magnitude of the requested balancing power) as balancing vehicles from the N power supply lane vehicles. Specifically, the control device 250 excludes the vehicles 100 not capable of dealing with the target balancing power (requested balancing power) from the N power supply lane vehicles based on the vehicle information (e.g., full charge capacity, SOC, rated charge power, and rated discharge power of the battery 110) of each vehicle 100 traveling in the power supply lanes of the road R10, and selects the remaining vehicles 100 as balancing vehicles. For example, the control device 250 may exclude the vehicles 100 with an SOC that is higher than a predetermined SOC (e.g., an SOC close to a fully charged state) from selection candidates when charging of the batteries 110 of the vehicles 100 is requested for power balancing of the power grid PG. The control device 250 may exclude the vehicles 100 with an SOC that is lower than a predetermined SOC (e.g., an SOC close to an empty state) from selection candidates when discharging of the batteries 110 of the vehicles 100 is requested for power balancing of the power grid PG. The control device 250 may select all the vehicles 100 remaining as selection candidates as balancing vehicles. However, the present disclosure is not limited to this, and the control device 250 may select a necessary number of vehicles 100 according to the target balancing power (requested balancing power) as balancing vehicles based on a predetermined criterion.

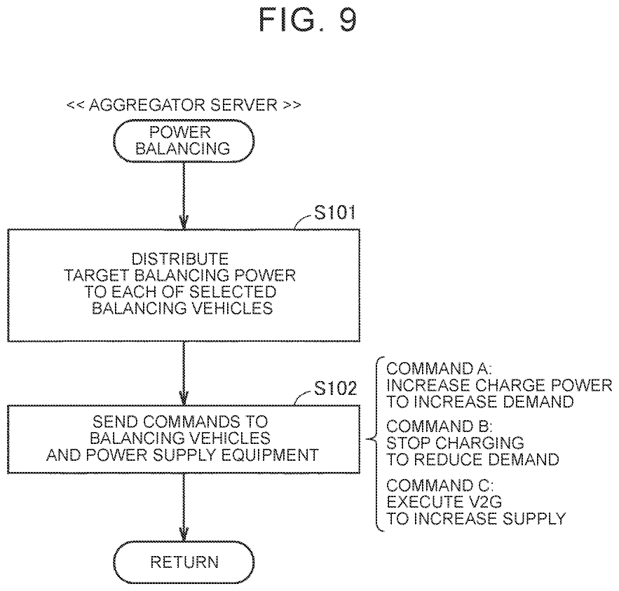

In the subsequent step S57, the control device 250 notifies a user terminal of each selected balancing vehicle of the start of power balancing. The user terminal may be a terminal mounted on the vehicle or a mobile terminal carried by the vehicle user. In the present embodiment, the process shown in FIG. 3 will not be performed on the balancing vehicles selected from the N power supply lane vehicles. Instead, charge and discharge control will be performed on the selected balancing vehicles according to the process shown in FIG. 9 that will be described later. On the other hand, those power supply lane vehicles not selected as the balancing vehicles can be supplied with electric power from the power supply lanes (travel lanes R1, R2) of the road R10 by the process shown in FIG. 3. However, the present disclosure is not limited to this, and the server 200 (control device 250) may prohibit charging from the power supply lanes (travel lanes R1, R2) of the road R10 when discharge for power balancing of the power grid PG is requested.

In the subsequent step S58, the control device 250 performs power balancing of the power grid PG. FIG. 9 is a flowchart showing details of power balancing.

Referring to FIG. 9 together with FIGS. 1, 2, and 5, in S101, the control device 250 distributes the target balancing power to each balancing vehicle. For example, when the target balancing power is the balancing power for charging (that is, when charging for power balancing is requested), the control device 250 determines the charge power for each balancing vehicle. The control device 250 may determine the charge power for each balancing vehicle based on the vehicle information of each balancing vehicle (e.g., the SOC and rated charge power of the battery 110). The control device 250 may allocate high charge power to the balancing vehicles with high rated charge power and the balancing vehicles with low SOC. When the target balancing power is the balancing power for discharging (that is, when discharging for power balancing is requested), the control device 250 determines the discharge power for each balancing vehicle. The discharge power allocated to the balancing vehicles may be 0 kW (charging is stopped). The control device 250 may determine the discharge power for each balancing vehicle based on the vehicle information of each balancing vehicle (e.g., the SOC and rated discharge power of the battery 110). The control device 250 may allocate high discharge power to the balancing vehicles with high rated discharge power and the balancing vehicles with high SOC.

In the subsequent step S102, the control device 250 sends a command to operate each balancing vehicle according to the balancing power (charge power or discharge power) determined in S101 (hereinafter this command will be referred to as “balancing command”) to each balancing vehicle traveling in the power supply lanes (travel lanes R1, R2) of the road. R10 and each piece of power supply equipment (power supply equipment 300A, 300B) installed in the power supply lanes of the road R10. The balancing commands together with the vehicle IDs of the balancing vehicles are transmitted to the power supply equipment 300A and the power supply equipment 300B.

Power balancing using WPT is performed between each balancing vehicle and the power supply equipment 300 (power supply equipment 300A or 300B) in a manner according to the process of FIG. 3. However, in S240, each balancing vehicle performs charge and discharge control according to the balancing command from the server 200 (control device 250). When the power supply equipment 300 receives the vehicle ID from a balancing vehicle by short-range communication (YES in S310), the power supply equipment 300 performs charge and discharge control according to the balancing command corresponding to this vehicle ID in S330. Power balancing of the power grid PG is performed as each balancing vehicle traveling in the power feeding lanes of the road R10 performs charge control, discharge control, or charge stop control according to the balancing command from the server 200. The control device 250 can increase the demand of the power grid PG by sending a command to increase the charge power of the battery 110 of the balancing vehicle (command A) to the balancing vehicles. The control device 250 can reduce an increase in demand of the power grid PG by sending a command to prohibit charging of the battery 110 of the balancing vehicle (command B) to the balancing vehicles. The control device 250 can increase supply of the power grid PG by sending a command to execute vehicle-to-grid (V2G) from the balancing vehicle to the power grid PG (command C) to the balancing vehicles.

When charging is requested by the generated balancing power request, the control device 250 sends a balancing command to perform charging with the charge power determined in S101 (first command) to each balancing vehicle. When the balancing vehicle (ECU 150) receives the balancing command to perform charging with the charge power determined in S101 (first command), the balancing vehicle (ECU 150) charges the battery 110 with the power from the power supply equipment 300 according to the received balancing command. When discharging is requested by the generated balancing power request, the control device 250 sends a balancing command to perform discharging of the discharge power determined in S101 or to stop charging (second command) to each balancing vehicle. When the balancing vehicle (ECU 150) receives the balancing command to perform discharging of the discharge power determined in S101 or to stop charging (second command), the balancing vehicle (ECU 150) discharges the battery 110 to the power grid PG or stops charging the battery 110 according to the received balancing command. The lane power is thus controlled according to the generated balancing power request. After step S102 is performed, the series of steps shown in FIG. 9 ends, and the routine proceeds to S59 in FIG. 8.

Referring to FIG. 8 together with FIGS. 1, and 5, in S59, the control device 250 determines whether the balancing duration of the generated balancing power request has ended. When the balancing duration has not ended (NO in S59), the routine returns to S51, and the above steps S51 to S54 are performed. In the second and subsequent routines, the control device 250 determines that power balancing of the power grid PG has already been started (YES in S54), and the routine proceeds to S55.

In S55, the control device 250 determines whether any of the balancing vehicles (balancing vehicles selected in the most recent S56) performing power balancing of the power grid PG has stopped performing power balancing of the power grid PG halfway through.

Specifically, the control device 250 monitors whether the balancing vehicles selected in response to the generated balancing power request are traveling in the power supply lanes of the road R10 during the balancing duration. The control device 250 may grasp the current traveling position of each balancing vehicle using the vehicle information (e.g., the positions of the vehicles) managed by the vehicle information DB 222. The control device 250 can sequentially acquire the latest data from the server 500. The control device 250 determines that the balancing vehicle has departed from the power supply lane in each of the following cases: when the balancing vehicle has left the power supply lane (travel lane R1 or R2) through its exit, and when the balancing vehicle has changed from the power supply lane (travel lane R1 or R2) to the no-power-supply lane (travel lane R3). When any of the balancing, vehicles has departed from the power supply lane (travel lane R1 or R2) of the road R10 during the balancing duration, the control device 250 determines that this balancing vehicle has stopped performing power balancing of the power grid PG halfway through.

The control device 250 also monitors the SOC of the battery 110 of each selected balancing vehicle during, the balancing duration. The control device 250 determines based on the SOC of the battery 110 of the balancing vehicle whether this balancing vehicle has stopped performing power balancing of the power grid PG halfway through. When the SOC of the battery 110 of the balancing vehicle is not within a predetermined range, the control device 250 determines that this balancing vehicle has stopped performing power balancing of the power grid PG halfway through, even when this balancing vehicle is traveling in the power supply lane of the road R10. For example, in the case where there is any balancing vehicle with a battery 110 that has an SOC equal to or larger than a predetermined SOC value (e.g., an SOC value indicating a fully charged state) when charging (increase in demand) is requested by the generated balancing power request, the control device 250 determines that this balancing vehicle has stopped performing power balancing of the power grid PG halfway through. In the case where there is any balancing vehicle with a battery 110 that has an SOC equal to or less than a predetermined SOC value (e.g., an SOC value indicating an empty state) when discharging (increase in supply) is requested by the generated balancing power request, the control device 250 determines that this balancing vehicle has stopped performing power balancing of the power grid PG halfway through. In the case where the SOC of the battery 110 of any balancing vehicle exhibits a change opposite, to the requested balancing power (decrease in response to a charge request or increase in response to a discharge request), the control device 250 determines that this balancing vehicle has stopped performing power balancing of the power grid PG halfway through.

In the case where any of the balancing vehicles stops performing power balancing of the power grid PG using the power supply equipment 300A, 300B before the balancing duration ends (YES in S55), the control device 250 selects a substitute vehicle from the vehicles 100 traveling in the power supply lanes of the road R10 (except the vehicles 100 that are performing power balancing of the power grid PG) in S56. The substitute vehicle is the vehicle 100 to be controlled to perform power balancing of the power grid PG in place of the balancing vehicle having stopped performing power balancing halfway through.

For example, the control device 250 selects a substitute vehicle based on the position of each vehicle 100 and at least one of the following values of the battery 110 of each vehicle 100: SOC, full charge capacity, rated charge power, and rated discharge power. Specifically, the control device 250 determines whether each of the vehicles 100 traveling in the power supply lanes of the road R10 can deal with the target balancing power (requested balancing power), based on at least one of the following values of the battery 110 of each vehicle 100: SOC, full charge capacity, rated charge power, and rated discharge power. The control device 250 excludes the vehicles 100 (balancing vehicles) that are performing power balancing of the power grid PG and the vehicles 100 that cannot deal with the target balancing power (requested balancing power) from the vehicles 100 traveling in the power supply lanes of the road R10, and selects the vehicle 100 located closest to the balancing vehicle having stopped power balancing of the power grid PG halfway through as a substitute vehicle from the remaining vehicles 100. When a plurality of balancing vehicles has stopped performing power balancing of the power grid PG halfway through, the control device 250 selects a substitute vehicle for each of those balancing vehicles.

Any vehicle 100 determined to have stopped performing power balancing of the power grid PG in S55 is excluded from the balancing vehicles in S56. The substitute vehicle selected in S56 becomes a new balancing vehicle. In the present embodiment, when any of the balancing vehicles stops performing power balancing of the power grid PG halfway through, the server 200 (control device 250) preferentially selects a vehicle 100 located near the balancing vehicle having stopped performing power balancing halfway through as a substitute vehicle from the vehicles 100 traveling in the power supply lanes of the road R10. The balancing power that acts on the power grid PG when the balancing vehicle transfers electric power to and from the power supply equipment 300A or 300B may vary depending on the position (location) of that balancing vehicle. In the above configuration, a vehicle located near the balancing vehicle having stopped performing power balancing is preferentially selected as a substitute vehicle. Therefore, the power supply lanes of the road R10 are likely to provide stable balancing power to the power grid PG.

When selection of a substitute vehicle (S56) ends, the control device 250 notifies the user terminal of the selected substitute vehicle of the start of power balancing in S57. Thereafter, in S58, power balancing of the power grid PG is performed by the new balancing vehicle.

When all of the balancing vehicles are continuing power balancing of the power grid PG (NO in S55), the routine skips S56 and S57 and proceeds to S58. That is, the balancing vehicles are not changed, and power balancing of the power grid PG is performed by the balancing vehicles in S58.

During the balancing duration, power balancing of the power grid PG is performed by the power supply lanes of the road R10 according to the step S58 described above (see FIG. 9). When the balancing duration ends (YES in S59), step S60 is performed. The series of steps shown in FIG. 8 then ends. In S60, the control device 250 notifies the user terminal of each balancing vehicle of the end of power balancing. The user terminal may be a terminal mounted on the vehicle or a mobile terminal carried by the vehicle user.

According to the power supply system having the configuration described. above (see FIGS. 1 to 9), the balancing vehicles (vehicles to be controlled for power balancing of the external power supply) can be selected from the vehicle group traveling in the power supply lanes so that the power supply lanes are likely to provide stable balancing power to the external power supply (power grid PG). The power balancing method according to the present embodiment includes the processes shown in FIGS. 6 to 9.

In S56 of FIG. 8, the server 200 selects the balancing vehicles to be controlled for power balancing of the power grid PG from the vehicles 100 traveling in the travel lanes (travel lanes R1, R2) provided with the power supply equipment 300A, 300B that is supplied with electric power from the power grid PG. In S58 of FIG. 8 (process shown in FIG. 9), the server 200 operates the balancing vehicles for power balancing of the power grid PG. In the process shown in FIG. 8, when any of the selected balancing vehicles stops performing power balancing of the power grid PG using the power supply equipment 300A, 300B halfway through (YES in S55), the server 200 selects in S56 a substitute vehicle to be controlled to perform power balancing of the power grid PG in place of the balancing vehicle having stopped power balancing halfway through from the vehicles 100 traveling in the power supply lanes (travel lanes R1, R2) of the road R10. In the process shown in FIG. 8, when YES in S55, the server 200 selects a substitute vehicle in S56, and then operates the substitute vehicle (new balancing vehicle) for power balancing of the power grid PG in S58 (process shown in FIG. 9). According to this method as well, the power supply lanes are likely to provide stable balancing power to the external power supply (power grid PG). Each vehicle 100 selected as a balancing vehicle or a substitute vehicle can perform power balancing of the power grid PG.

The vehicle management device 1000 may be configured to divide the power supply lanes of the road R10 into a plurality of blocks and perform area management of the road R10 on a block-by-block basis. The vehicle management device 1000 may be configured to, when it is determined in S55 of FIG. 8 that any of the selected balancing vehicles has stopped performing power balancing of the external power supply (power grid PG) halfway through, preferentially select a vehicle 100 traveling in the same block as the block in which the balancing vehicle having stopped performing power balancing halfway through is traveling or in a block associated with that block as a substitute vehicle in the subsequent step S56.

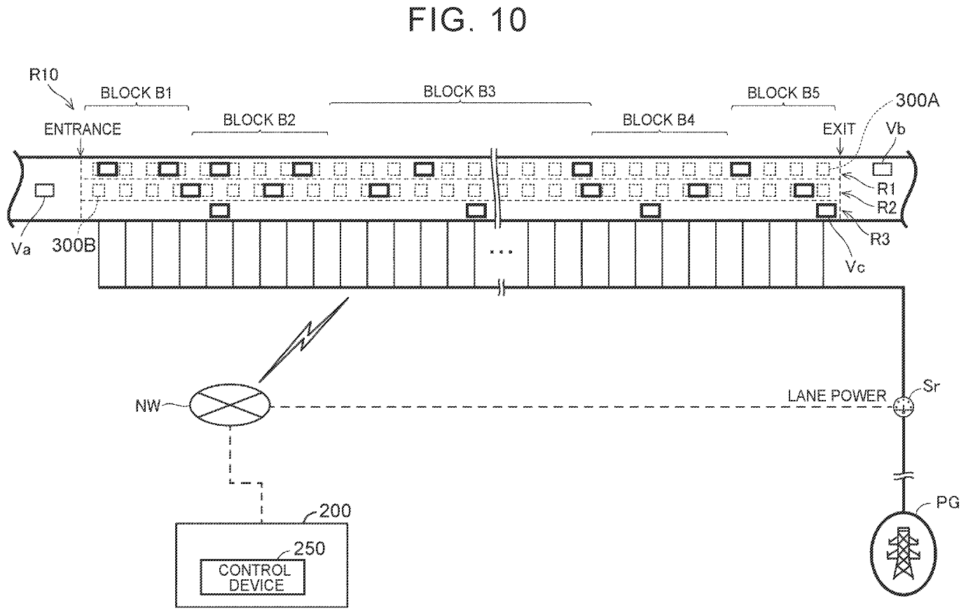

FIG. 10 shows a modification of the method for selecting a substitute vehicle. Referring to FIG. 10, in this modification, the control device 250 of the server 200 divides the power supply lanes of the road R10 into blocks B1 to B5 and performs area management on a block-by-block basis. Information on the division of the power supply lanes into blocks (block information of blocks B1 to B5) is stored in the map information DB 221 (FIG. 2). The power supply lanes of the road R10 are divided into five blocks, that is, a block B1 (first block) near the entrance, a block B3 (third block) in the middle, a block B5 (fifth block) near the exit, a block B2 (second block) between the blocks B1, B3, and a block B4 (fourth block) between the blocks B3, B5.

Balancing power acts on the power grid PG when the power supply lanes are charged or discharged in each of the blocks B1 to B5. Of the blocks B1 to B5, two or more blocks that are similar in the balancing power that acts on the power grid PG are stored in the map information DB 221 in association with each other. In this modification, in S56 of FIG. 8, the control device 250 of the server 200 preferentially selects a vehicle 100 traveling in the same block of the power supply lanes of the road R10 as the block in which the balancing vehicle having stopped performing power balancing halfway through is traveling or in a block associated with that block as a substitute vehicle. For example, in the form in which the blocks B2, B4 are similar in the balancing power that acts on the power grid PG when the balancing vehicle transfers electric power to and from the power supply equipment 300A, 300B, the blocks B2, B4 are stored in the map information DB 221 in association with each other. Therefore, when any of the balancing vehicles traveling in the block B2 stops performing power balancing halfway through, the control device 250 selects a vehicle 100 traveling in the block B2 or B4 as a substitute vehicle for that balancing vehicle. A vehicle 100 traveling in the same block B2 as the balancing vehicle having stopped performing power balancing halfway through may be selected as a substitute vehicle in preference to a vehicle 100 traveling in the block B4 associated with the block B2. The order of priority for selecting a substitute vehicle within a single block can be set as desired. For example, in the above form, the control device 250 may preferentially select a vehicle 100 suitable for the requested power balancing as a substitute vehicle, based on the vehicle information of each vehicle 100 traveling in a single block (e.g., the block B2).

In the power supply system according to the modification, a vehicle 100 traveling in the same block as the block in which the balancing vehicle having stopped performing power balancing halfway through is traveling or in a block associated with that block is preferentially selected as a substitute vehicle. Therefore, the power supply lanes of the road R10 are likely to provide stable balancing power to the power grid PG. The method for dividing the power supply lanes into blocks is not limited to the example shown in FIG. 10. The number of blocks is also not limited to five, and the power supply lanes may be divided into any desired number of blocks.

In the form in which the vehicle group VG managed by the vehicle management device 1000 includes vehicles promised to cooperate in power balancing by contract (virtual power plant (VPP) contract vehicles) and other vehicles (non-VPP contract vehicles), the vehicle management device 1000 may exclude the non-VPP contract vehicles from the processes shown in FIGS. 6 to 9.

Each vehicle 100 (FIG. 2) in the above embodiment is equipped with an energy storage device configured to be charged with electric power from the travel lane of the road R10 on which the vehicle 100 is traveling. In the form in which the vehicle group VG managed by the vehicle management device 1000 includes vehicles not equipped with an energy storage device configured to be charged with electric power from the travel lane of the road R10 on which the vehicle is traveling (non-charging vehicles), the vehicle management device 1000 may exclude the non-charging vehicles from the processes shown in FIGS. 8 and 9 when charging for power balancing of the power grid PG (external power supply) is requested.

Each vehicle 100 (FIG. 2) in the above embodiment is equipped with an energy storage device configured to discharge electric power to the power grid PG via the travel lane of the road R10 on which the vehicle 100 is traveling. In the form in which the vehicle group VG managed by the vehicle management device 1000 includes vehicles not equipped with an energy storage device configured to discharge electric power to the power grid PG via the travel lane of the road R10 on which the vehicle is traveling (non-V2G vehicles), the vehicle management device 1000 may exclude the non-V2G vehicles from the processes shown in FIGS. 8 and 9 when discharging for power balancing of the power grid PG (external power supply) is requested.

The road to which the power supply system is applied is not limited to the road R10 shown in FIG. 5. The road to which the power supply system is applied may be a local road or an expressway. A gate through which only predetermined vehicles (e.g., managed vehicles or vehicles that have reserved the power supply equipment installed in the power supply lane) are allowed to pass may be installed at the entrance of the power supply lanes of the road R10. The power supply lane (area of the road in which the power supply equipment is installed) may have any desired length. For example, the length of the power supply lane may be 5 km or more and 100 km or less, or may be several kilometers. The road R10 shown in FIG. 5 has two power supply lanes and one no-power-supply lane. However, the road R10 may have more no-power-supply lanes than power supply lanes. The above power supply system may be applied to a road having one power supply lane or three or more power supply lanes, or a road having no no-power-supply lane.

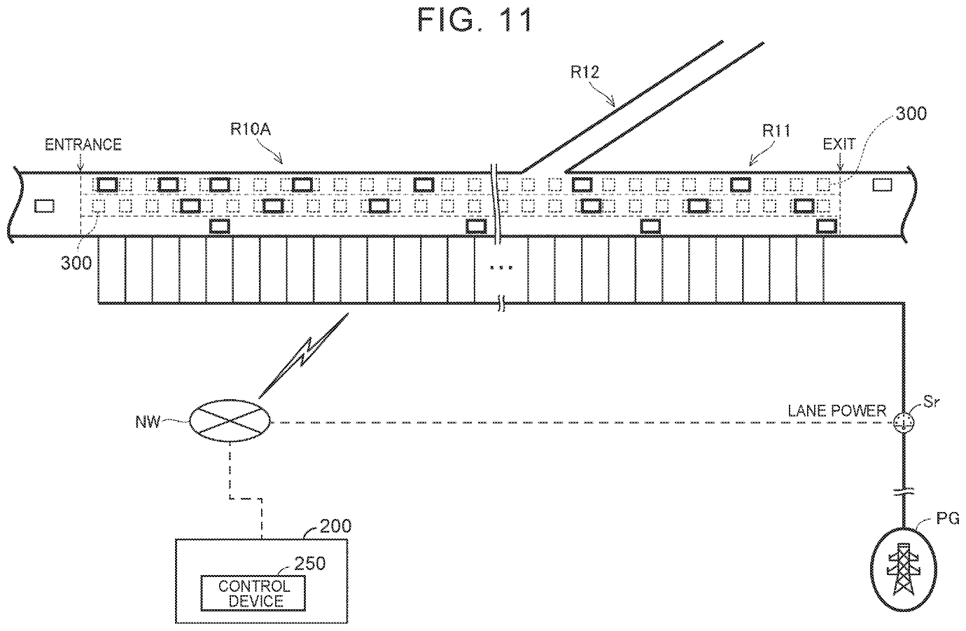

FIG. 11 shows a modification of the road R10 shown in FIG. 5. Referring to FIG. 11, a road R10A including power supply lanes divides into a first road R11 including the power supply lanes and a second road R12 not including any power supply lane (no-power-supply lane). In S55 of FIG. 8, when any of the balancing vehicles traveling on the power supply lanes of the road R10A takes the second road R12, the control device 250 may determine that this balancing vehicle has stopped performing power balancing of the power grid PG halfway through.

The configuration of the system is not limited to the configuration shown in FIG. 1. Another server (e.g., a server of a higher-level aggregator) may be provided between the server 700 and the server 200. In the above embodiment, the servers 200, 500 are on-premises servers (see FIG. 1). However, the present disclosure is not limited to this, and the functions of the servers 200, 500 (particularly, the functions related to vehicle management) may be implemented in a cloud by cloud computing. At least a part of the functions of the server 500 may be implemented in the server 200.

The configuration of the managed vehicle is not limited to the configuration described in the above embodiment (see FIG. 2). The vehicle group VG may include a plurality of types of managed vehicles having different configurations. The configuration of the managed vehicle may be changed as appropriate to a configuration exclusively for manned driving or a configuration exclusively for unmanned driving. For example, a vehicle exclusively for unmanned driving need not necessarily include parts for a person to operate the vehicle (such as a steering wheel). The configuration of the managed vehicle is not necessarily limited to the configuration having an automated driving function.

The managed vehicle may be an xEV other than a BEV. The managed vehicle may be an xEV (hybrid electric vehicle, fuel cell electric vehicle, range extender electric vehicle (EV), etc.) configured to be charged while traveling and/or discharged while traveling. The managed vehicle may be a hybrid electric vehicle equipped with a hydrogen engine and an energy storage device. The managed vehicle may be equipped with a solar panel or may have a flight function. The managed vehicle is not limited to a passenger car, and may be a bus or a truck. The managed vehicle may be a personally owned vehicle (POV), or a mobility as a service (MaaS) vehicle. A MaaS vehicle is a vehicle managed by a MaaS service provider. The managed vehicle may be a multipurpose vehicle that is customized according to the user's purpose of use. The managed vehicle may be a mobile shop vehicle, a robotaxi, an automated guided vehicle (AGV), or an agricultural machine. The managed vehicle may be an unmanned or one-seater small BEV (e.g., a Micro Palette or an electric scooter).

The embodiment disclosed herein should be considered to be illustrative and not restrictive in all respects. The technical scope of the present disclosure is shown by the claims rather than by the above description of the embodiment, and is intended to include all modifications within the meaning and scope equivalent to the claims.

What is claimed is:

1. A power supply system, comprising:
power supply equipment configured to be supplied with electric power from an external power supply and supply the electric power to a vehicle traveling in a travel lane; and
a vehicle management device configured to manage a plurality of vehicles configured to transfer electric power to and from the power supply equipment, wherein the vehicle management device is configured to:
select balancing vehicles to be controlled for power balancing of the external power supply from the vehicles;
determine whether control of the balancing vehicles for power balancing of the external power supply has been stopped halfway through; and
when the vehicle management device determines that the control of any of the balancing vehicles for power balancing of the external power supply has been stopped halfway through, newly select a substitute vehicle to be controlled to perform power balancing of the external power supply from the vehicles traveling in the travel lane.

2. The power supply system according to claim 1, wherein the vehicle management device is configured to:
when power balancing of the external power supply for a predetermined balancing duration is requested, monitor whether the balancing vehicles are traveling in the travel lane during the balancing duration; and
when any of the balancing vehicles has departed from the travel lane during the balancing duration, determine that the control of the balancing vehicle having departed from the travel lane for power balancing of the external power supply has been stopped halfway through.

3. The power supply system according to claim 2, wherein:
the travel lane is located on a same road as a no-power-supply lane; and
the vehicle management device is configured to determine that the balancing vehicle has departed from the travel lane when the balancing vehicle has left the travel lane through an exit of the travel lane and when the balancing vehicle has changed from the travel lane to the no-power-supply lane.

4. The power supply system according to claim 1, wherein the vehicle management device is configured to:
monitor a state of charge of an energy storage device of a balancing vehicle; and
determine based on the state of charge of the energy storage device of the balancing vehicle whether the control of the balancing vehicle for power balancing of the external power supply has been stopped halfway through.

5. The power supply system according to claim 1, wherein the vehicle management device is configured to, when the vehicle management device determines that the control of any of the balancing vehicles for power balancing of the external power supply has been stopped halfway through, preferentially select a vehicle located near the balancing vehicle the control of which has been stopped halfway through as the substitute vehicle from the vehicles traveling in the travel lane.

6. The power supply system according to claim 1, wherein the vehicle management device is configured to:
divide the travel lane into a plurality of blocks and perform area management on a block-by-block basis; and
when the vehicle management device determines that the control of any of the balancing vehicles for power balancing of the external power supply has been stopped halfway through, preferentially select a vehicle traveling in the same block of the travel lane as the block in which the balancing vehicle the control of which has been stopped halfway through is traveling or a block associated with the block as the substitute vehicle.

7. The power supply system according to claim 1, wherein the vehicle management device is configured to, when the vehicle management device determines that the control of any of the balancing vehicles for power balancing of the external power supply has been stopped halfway through, select the substitute vehicle from the vehicles traveling in the travel lane based on at least one of the following values of energy storage devices of each of the vehicles: state of charge, full charge capacity, rated charge power, and rated discharge power.

8. The power supply system according to claim 1, wherein the vehicle management device is configured to:
determine charge power for each of the balancing vehicles when charging of energy storage devices of the balancing vehicles is requested for power balancing of the external power supply; and
send a first command to perform charging with the determined charge power to the balancing vehicles traveling in the travel lane.

9. The power supply system according to claim 1, wherein the vehicle management device is configured to:
determine discharge power for each of the balancing vehicles when discharging of energy storage devices of the balancing vehicles is requested for power balancing of the external power supply; and
send a second command to perform discharging of the determined discharge power or to stop charging to the balancing vehicles traveling in the travel lane.

10. The power supply system according to claim 1, wherein the vehicle management device is configured to predict the number of vehicles that are going to be traveling in the travel lane during a predetermined period, and bid on balancing power for the predetermined period on an electricity market based on the predicted number of vehicles.

11. A server configured to manage a plurality of vehicles, the vehicles being configured to transfer electric power to and from power supply equipment that is supplied with electric power from an external power supply and supplies the electric power to a vehicle traveling in a travel lane, wherein the server is configured to:
select balancing vehicles to be controlled for power balancing of the external power supply from the vehicles; and
when control of any of the balancing vehicles for power balancing of the external power supply has been stopped halfway through, newly select a substitute vehicle to be controlled to perform power balancing of the external power supply from the vehicles traveling in the travel lane.

12. A power balancing method, comprising: selecting balancing vehicles to be controlled for power balancing of an external power supply from vehicles traveling in a travel lane equipped with power supply equipment configured to be supplied with electric pow the external power supply;
controlling the balancing vehicles for power balancing of the external power supply;
determining whether control of the balancing vehicles for power balancing of the external power supply has been stopped halfway through;
when determination is made that the control of any of the balancing vehicles for power balancing of the external power supply has been stopped halfway through, newly selecting a substitute vehicle to be controlled to perform power balancing of the external power supply from the vehicles traveling in the travel lane; and
controlling the substitute vehicle for power balancing of the external power supply.
